(19) United States
(12) Patent Application Publication
(10) Pub. No.: US 2008/0134890 A1
(43) Pub. Date: Jun. 12, 2008

(54) Method and apparatus for cleaning the waste gases from a silicon thin-film production plant

(76) Inventors: Dietmar Lundszien, Muenchen (DE); Franz Irsigler, Marzling (DE); Peter Lechner, Vaterstetten (DE)

Correspondence Address: FLYNN THIEL BOUTELL & TANIS, P.C., 2026 RAMBLING ROAD, KALAMAZOO, MI, 49008-1631, US

(21) Appl. No.: 11/982,725

(22) Filed: Nov. 2, 2007

(30) Foreign Application Priority Data
Nov. 8, 2006 (DE) 10 2006 052 586.8

(51) Int. Cl. B01D 47/00

(52) U.S. Cl. 95/178; 96/242

(57) ABSTRACT

A plant for producing silicon thin-film solar cells has at least one chamber (1) in which the silicon thin-film is deposited from silicon hydride gas during the production process. The chamber (1) is subsequently cleaned of contaminants by an etching process e.g. with sulfur hexafluoride as the etchant gas. The waste gas formed during the production process and containing silicon hydride is supplied to a burner (6) and subsequently filtered. The waste gas formed during the etching process and containing sulfur hexafluoride is washed with water after having been supplied to a burner. The hydrofluoric acid formed by burning of the sulfur hexafluoride is separated from the washing water.

This invention relates to a method and apparatus for cleaning waste gas from a plant with which a silicon film is deposited from silicon hydride, according to the preambles of claims 1 and 5.

The silicon of a silicon thin-film solar cell is produced from a process gas of silicon hydride, hydrogen and e.g. nitrogen as the carrier gas in a chamber by chemical vapor deposition, in particular plasma enhanced chemical vapor deposition, or PECVD. Silicon is thereby deposited not only on the substrate, that is, the solar cell, but also on the chamber walls and the electrode with which the plasma is produced.

The chamber must therefore be cleaned after the production process. For this purpose a PECVD etching process is carried out with an etchant gas comprising a nonmetal fluoride, in particular sulfur hexafluoride and nitrogen trifluoride, and oxygen as well as nitrogen as the carrier gas to convert the silicon deposited in the chamber into volatile silicon-fluorine compounds. During the etching process only a small portion of the nonmetal fluoride used is converted into silicon-fluorine compounds, however. The predominant portion of the nonmetal fluoride remains unused.

Both in the production process and in the etching process the chamber must be pumped out to maintain the vacuum required for plasma formation. Two methods are common for cleaning the pumped out process waste gas and etching waste gas.

On the one hand, both the waste process gas containing silicon hydride and the waste gas formed during the etching process and containing the etchant gas and silicon fluoride are supplied to a burner which is followed by a washing device. If sulfur hexafluoride is used as the etchant gas, the silicon hydride is burned to silicon dioxide and water, the sulfur hexafluoride into sulfur dioxide and hydrofluoric acid, and the silicon fluoride to silicon dioxide and hydrofluoric acid, whereby the silicon dioxide, sulfur dioxide and hydrofluoric acid are washed out of the combustion gas with water by the washing device. In contrast, e.g. nitrogen trifluoride as the etchant gas is burned to nitric oxides. This not only involves a considerable water consumption, but rather a considerable amount of waste water is formed which contains both poorly separable silicon dioxide sludge and aggressive hydrofluoric acid, so that the waste water cleaning causes considerable problems.

According to the other method, the process waste gas and the waste gas formed during the etching process and containing sulfur hexafluoride or nitrogen trifluoride as the etchant gas and silicon fluoride are cleaned separately. The process waste gas is supplied to a burner and the silicon dioxide dust formed from the silicon hydride by burning is filtered out with a dust filter, while the sulfur hexafluoride or nitrogen trifluoride from the waste gas formed during the etching process is recycled to be reusable as etchant gas. However, cleaning the waste gas for recycling the etchant gas is very equipment-intensive.

It is therefore the problem of the invention to provide a method for cleaning the waste gases from a silicon thin-film production plant that is not very equipment-intensive and involves small amounts of washing water.

This is obtained according to the invention by the method characterized in claim 1. Advantageous embodiments of the inventive method are rendered in claims 2 to 4. Claim 5 relates to a preferred apparatus for carrying out the inventive method, being developed advantageously by the features of claims 6 to 9.

According to the inventive method, the waste gas formed during the production process, that is, during the deposition of the silicon film on the substrate, and containing surplus silicon hydride is supplied to a burner for it to be burned to silicon dioxide dust which can be easily filtered out. Likewise, the waste gas formed during the etching process and containing e.g. sulfur hexafluoride or nitrogen trifluoride is first burned, the combustion gas containing sulfur dioxide or nitric oxides and hydrofluoric acid (HF) is subsequently washed with water, and the hydrofluoric acid separated from the washing water.

The silicon fluoride formed in a relatively small amount in the waste gas during the cleaning or etching process by etching from the silicon deposited as a contaminant in the chamber is likewise burned here to silicon dioxide and hydrofluoric acid, whereby the silicon dioxide can optionally be separated together with the hydrofluoric acid.

The separation of the hydrofluoric acid can be effected here by precipitation, e.g. with calcium ions and subsequent filtering out of the precipitated deposit. Thus, only simple equipment such as burners, washers and filtering devices are required according to the invention.

Since only the combustion gas formed from the waste gas arising during the etching process is washed with water according to the invention, and the etching process takes considerably less time than the production process, only a small amount of washing water also arises according to the invention. Moreover, said washing water contains only a small amount of silicon dioxide, namely only the silicon dioxide resulting by burning in the burner from the silicon fluoride resulting from the etching process. Moreover, the concentration of hydrofluoric acid in the washing water is relatively high, which facilitates its precipitation.

In practice, the silicon dioxide load in the fluorine-containing waste water is thus reduced by a factor of approx. 8 to 20. Since the washing device need only run during the cleaning process, i.e. only 10 to 20% of the time, the fluorine-containing waste water volume to be disposed of is reduced accordingly.

At the same time, the devices used for cleaning according to the invention, namely burner, washing device and filtering device, are not only economical but also technically proven plant components. Since the waste gas formed during the production process and the waste gas formed during the etching process are cleaned separately, there is moreover the possibility of optimizing the cleaning efficiency of the particular cleaning process.

The inventive method can be used in a silicon thin-film production plant with one or with a plurality of chambers. Upon use of two or more chambers, the production process is preferably carried out alternately in one chamber while the other chamber is subjected to the etching process for cleaning.

The silicon hydride gas used is preferably monosilane (SiH₄). It is supplied in a mixture with hydrogen. The carrier gas used is preferably nitrogen. Thus, the volume ratio of SiH₄ to H₂ can be e.g. 1 to 50, in particular 8 to 30, standard liters per minute of H₂ to 10 standard liters per minute of SiH₄. The volume ratio of nitrogen to the mixture of SiH₄ and H₂ can be e.g. 2:1 to 20:1, in particular 4:1 to 8:1. The duration of deposition can be for example 20 to 60 minutes.

For deposition it is preferable to use the PECVD method, preferably with a vacuum of 01 to 0.5 millibars. The vacuum in the PECVD etching method is preferably within the same range.

For the etching process a mixture of a nonmetal fluoride etchant gas, in particular sulfur hexafluoride (SF₆) or nitrogen trifluoride (NF₃), and oxygen (O₂) is used. The volume ratio of nonmetal fluoride etchant gas to O₂ can be e.g. 2:1 to 8:1, in particular 3:1 to 4:1, standard liters per minute. The carrier gas used for said mixture is preferably likewise nitrogen. The volume ratio of nitrogen gas to the mixture of nonmetal fluoride etchant gas and O₂ can be e.g. 2:1 to 20:1, in particular 5:1 to 8:1. The duration of cleaning can be e.g. 3 to 10 minutes.

For separating the hydrofluoric acid from the washing water, the fluoride ions can be precipitated for example with calcium hydroxide or a water-soluble calcium salt.

Since the inventive method can be carried out with economical devices, said devices can also be used redundantly to increase the safety. For example, each burner can have a substitute burner associated therewith, the dust filter a substitute filter, the washing device a substitute washing device, etc.

The connection of the chamber or chambers to the one burner followed by a dust filter and to the other burner followed by the washing device is effected via a shut-off device in each case. The shut-off device can be constituted by a valve, a cock or the like; for example a three-way cock can be used.

An embodiment of the inventive apparatus hereinafter is explained by way of example with the attached drawing more precisely. Therein is shown schematically:

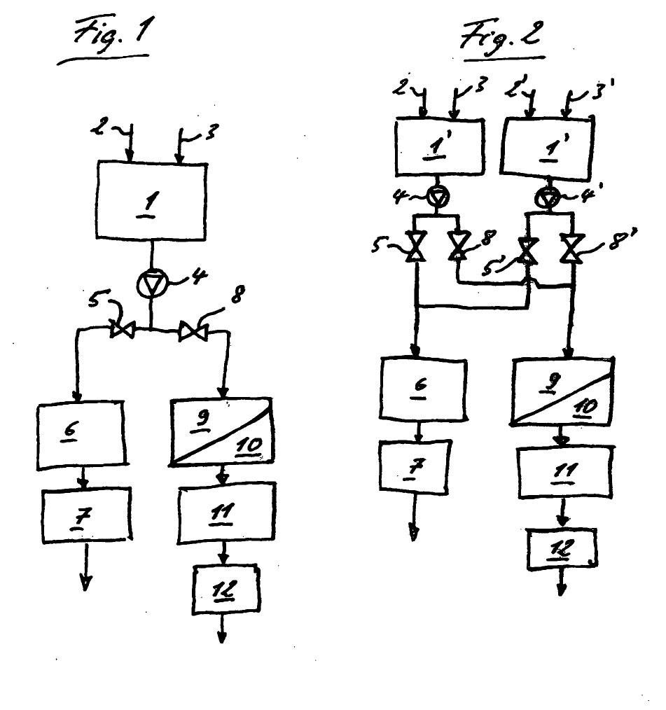

FIG. 1 a cleaning apparatus for one chamber; and

FIG. 2 a cleaning apparatus for two chambers.

According to FIG. 1, a plant for producing a silicon thin-film/solar cell has a PECVD chamber 1 to which a gas comprising SiH₄ and H₂ as well as N₂ as the carrier gas is supplied according to the arrow 2 during the production process, and a mixture of SF₆ (or NF₃) and O₂ as well as N₂ as the carrier gas is supplied according to the arrow 3 during the cleaning process.

At the same time a low pressure of e.g. 0.3 millibars is adjusted in the chamber 1 with a pump 4.

The pump 4 is connected, on the one hand, via the valve 5 to a burner 6 which is followed by a filter 7 and, on the other hand, via a valve 8 to a burner 9 which at the same time comprises a washing device 10. The washing device 10 is followed by a tank 11 with a filter 12 for the waste water treatment, including fluoride precipitation.

During the production process the valve 5 is open and the valve 8 closed. The waste gas pumped out of the chamber 1 by the pump 4 and containing SiH₄, H₂ and N₂ is thus supplied to the burner 6 and burned to SiO₂ and H₂O there, the SiO₂ dust being separated with the filter 7 before the waste gas is released into the open.

During the etching or cleaning process the valve 5 is closed and the valve 8 open. The waste gas drawn out of the chamber 1 by the pump 4 and containing SF₆ (or NF₃), O₂, silicon fluoride and N₂ is thus supplied to the burner 9 and burned to SO₂ or NO, HF and SiO₂ there, which are washed out with the washing device 10. The washing water which is supplied to the tank 11 is mixed e.g. with calcium hydroxide to precipitate calcium fluoride, which is filtered out together with the silicon dioxide with the filter 12, to be released as cleaned waste water.

The apparatus according to FIG. 2 differs substantially from that according to FIG. 1 in that two PECVD plants 1, 1′ each with a pump 4, 4′ are provided, whereby the pumps 4, 4′ connect the chambers 1, 1′ via the valves 5, 8 or 5′, 8′ to the burner 6 or the burner 9.

Instead, two chambers can also be provided, whereby for each of the two chambers a burner with a following dust filter and a burner with a following washing device and a separating device for the hydrofluoric acid are provided. To permit the operation of the plant to be continued upon failure of a burner, a substitute burner which is connectable to one or the other chamber can be provided e.g. for the burner with a following washing device.

1. A method for cleaning the waste gases from a plant having at least one chamber (1, 1′) in which a production process is carried out wherein a silicon film is deposited on a substrate from silicon hydride, the chamber (1, 1′) being cleaned of contamination from deposited silicon, after production, by an etching process with a nonmetal fluoride etchant gas, characterized in that the waste gas formed during the production process and containing silicon hydride is supplied to a first burner (6) and subsequently filtered with a first filter (7) for removal of the silicon dioxide dust formed by burning of the silicon hydride, and the waste gas formed during the etching process and containing nonmetal fluoride etchant gas is washed with water after having been supplied to a second burner (9), whereupon the hydrofluoric acid formed by burning of the nonmetal fluoride etchant gas is precipitated out of the washing water and separated with a second filter (12) together with the silicon dioxide formed by burning of the silicon fluoride resulting from the etching process.

2. The method according to claim 1, characterized in that sulfur hexafluoride and/or nitrogen trifluoride is used as the nonmetal fluoride etchant gas.

3. The method according to claim 1, characterized in that the plant has at least two chambers (1, 1′), the production process being carried out alternately in one chamber (1, 1′) while the other chamber (1, 1′) is cleaned by the etching process.

4. An apparatus for carrying out the cleaning method according to claim 1, characterized in that the at least one chamber (1, 1′) is connectable, for removal of the waste gas formed during the production process and containing silicon hydride, via a shut-off device to a first burner (6) which is followed by a first filter (7) for removal of the silicon dioxide dust formed by burning of the silicon hydride, and is connectable, for removal of the waste gas formed during the etching process and containing nonmetal fluoride etchant gas, via a shut-off device to a second burner (9) which is followed by a washing device (10) for washing the hydrofluoric acid formed by burning of the nonmetal fluoride etchant gas out of the combustion gases with water, a device for precipitating the hydrofluoric acid from the washing water, and a second filter (12) for separating the precipitated hydrofluoric acid and the silicon dioxide which is formed by burning of the silicon fluoride resulting from the etching process.

5. The apparatus according to claim 4, characterized in that a substitute burner is provided in each case in addition to the first burner (6) with the following first filter (7) and/or the second burner (9) with the washing device (10).

6. The apparatus according to claim 4, characterized in that the plant has at least two chambers (1, 1′) in which alternately either the production process or the etching process is carried out, each chamber (1, 1′) being connectable via a shut-off device to the first burner (6) with the following dust filter (7) and via a shut-off device to the second burner (9) with the washing device and hydrofluoric acid separating device.
